(19) United States
(12) Patent Application Publication
(10) Pub. No.: US 2010/0158852 A1
(43) Pub. Date: Jun. 24, 2010

(54) METHOD FOR REDUCTION OF MICROBES ON SURFACES

(76) Inventors: Wilson Kurt WHITEKETTLE, Jamison, PA (US); Juan Jiang, Shanghai (CN); Xudong Huang, Shanghai (CN)

Correspondence Address: General Electric Company;GE Global Patent Operation, 2 Corporate Drive, Suite 648, Shelton, CT, 06484, US

(21) Appl. No.: 12/340,892

(22) Filed: Dec. 22, 2008

(51) Int. Cl. A01N 55/10; A01P 1/00

(52) U.S. Cl. 424/78.37

(57) ABSTRACT

A method has been found for the removal of microbial biofilm on surfaces in contact with systems, including but not limited to aqueous systems, which comprises adding to the aqueous system an effective amount of a polyalkyleneoxide polysiloxane surfactant to substantially remove microbial biofilm, from surfaces in aquatic systems, while presenting minimal danger to non-target aquatic organisms at discharge due to their very low discharge concentrations.

### FIELD OF THE INVENTION

The field of the invention relates to methods for removing microbial biofilm from surfaces in contact with systems, including but not limited to aqueous systems. More particularly, the invention relates to the use of biodispersants in removal of microbial biofilm.

### BACKGROUND OF THE INVENTION

It is well known that bacteria attach to surfaces in any non-sterile aquatic environment. Industrial efforts to prevent colonization or to clean fouled surfaces amount to costly expenditures in many industries. Often such expenditures are made for cleaning programs that include the use of surfactants. Surfactants are regularly applied in water treatment programs as agents believed to play a role in the removal of organic masses from surfaces, in the enhancement of biocide efficacy or in the assistance of water miscibility of various biocidal agents. Surfactants are also generally used in agrichemical businesses, particularly to increase the effectiveness of herbicides. This is accomplished by using the surfactants to alter the surface area of the applied droplets, maximizing their interaction with leaf surfaces.

There are numerous examples of surfactants that inhibit the colonization of surfaces by inhibiting the overall growth of organisms in the growth target environment. Most surfactants, regardless of class, inhibit surface colonization when used in concentrations high enough to impede bacterial growth. In the water treatment industry, the most well known surfactants, which impart a measure of colonization resistance to submerged surfaces, include the cationic quaternary amine surfactants, which also function as biocides. Other surfactants, including those which are categorized as anionic or non-ionic in chemical character, act to change the surface energy and prevent the microbes from attaching or growing at the water/surface interface. However, even relatively mild non-ionic or anionic surfactants can exhibit toxic effects upon microbes, such as bacteria, algae or fungi. The concentration of non-ionic surfactants necessary to mediate toxicity is typically substantially higher than for cationic surfactants. Additionally, the more non-toxic surfactants often require higher levels of concentrations to achieve their purpose, thereby making them uneconomical, prone to forming high level of unwanted foam, and toxic to non-target aquatic organisms upon discharge to common receiving bodies of water.

One would expect nontoxic control of surface colonization to require the use of high concentration of surfactants, which is not possible in water treatment industries where thousands or millions of gallons of water would be treated. Accordingly, a need exists for a surfactant that can be used in water treatment industries, exhibiting low levels of toxicity when released into the environment, and which is effective at low dosages to inhibit or remove biofilm in aqueous systems so there is an economical advantage.

### SUMMARY OF THE INVENTION

A method has been found for the prevention or removal of microbial biofilm on surfaces in contact with systems, such as but not limited to, aqueous systems, which comprises adding to the system an effective amount of Si-based surfactants, known as polyalkyleneoxide polysiloxanes to substantially remove microbial biofilm, from surfaces in systems, such that effluents discharged from the system present minimal danger to non-target aquatic organisms due to their very low discharge concentrations. At these low concentrations, the product also produces no stable foam. The polyalkyleneoxide polysiloxanes exhibit exceptional surface tension reduction characteristics, providing surface tension reductions of 20-30 dynes/cm at concentrations equal to or below that of conventional all carbon-based anionic and non-ionic surfactants. This property gives the polysiloxanes the ability to readily infiltrate into known water channels of exopolysaccharides (microbial biofilm) and disrupt the polysaccharide bonds that anchor the attached biomass to submerged solid surfaces. The polyalkyleneoxide polysiloxanes also show excellent compatibility with traditional oxidizing and non-oxidizing biocides. These surfactants can be used in conjunction with oxidizing biocides such as chlorine, bromine, halogenated hydantoins, chlorine dioxide, hydrogen peroxide, ozone, perborates, perchlorates, permanganates, as well as non-oxidizing biocides such as bronopol, isothiazolins, DBNPA, quaternary ammonium salts, methylene bis thiocyanate, dodecylguanidines, and others, to dislodge and disinfect surface-released biofilm masses. This type of combined treatment has an additional advantage, as the polysiloxane surfactant can greatly reduce the overall toxicity of the biocontrol program by reducing the amount of biocide needed for biofilm control. Additionally, due to the low dosage required, economical advantages are realized as well.

The various features of novelty that characterize the invention are pointed out with particularity in the claims annexed to and forming a part of this disclosure. Changes to and substitutions of the various components of the invention can of course be made. The invention resides as well in sub-combinations and sub-systems of the elements described, and in methods of using them.

### BRIEF DESCRIPTION OF THE DRAWINGS

Refer now to the figures, which are meant to be exemplary and not limiting, and wherein like elements are numbered alike, and not all numbers are repeated in every figure for clarity of the illustration.

FIG. 1 is a chart depicting the results from biofilm removal efficacy in beaker test.

FIG. 2 is a chart depicting the results from biofilm removal at 50 ppm level for a 6 well plate test.

FIG. 3 is a chart depicting the results from biofilm removal at 50 ppm level for a 12 well plate test.

### DESCRIPTION OF THE INVENTION

Approximating language, as used herein throughout the specification and claims, may be applied to modify any quantitative representation that could permissibly vary without resulting in a change in the basic function to which it is related. Accordingly, a value modified by a term or terms, such as “about”, are not limited to the precise value specified. In at least some instances, the approximating language may correspond to the precision of an instrument for measuring the value. Range limitations may be combined and/or interchanged, and such ranges are identified and include all the sub-ranges included herein unless context or language indicates otherwise. Other than in the operating examples or where otherwise indicated, all numbers or expressions referring to quantities of ingredients, reaction conditions and the like, used in the specification and the claims, are to be understood as modified in all instances by the term “about”.

As used herein, the terms “comprises,” “comprising,” “includes,” “including,” “has,” “having” or any other variation thereof, are intended to cover a non-exclusive inclusion. For example, a process, method, article or apparatus that comprises a list of elements is not necessarily limited to only those elements, but may include other elements not expressly listed or inherent to such process, method article or apparatus.

In one embodiment of the present invention, a dispersant removes or reduces microbial slime from surfaces in contact with aqueous systems, such as industrial water systems, better than that resulting from water alone. Microbial slime includes, but is not limited to, metabolizing cells plus exopolysaccharides which form an extracellular mass in which a microbial colony grows. Sessile (free-floating) organisms may attach to surfaces of an aqueous system, exude various exopolysaccharides which may include natural surfactants, and gradually form a mat or film of like organisms, generally referred to as a biofilm. Such biofilm is to be avoided in aqueous systems as it may degrade the aqueous system, such as but not limited to, harboring pathogens, providing a niche for growth of anaerobic corrosion-causing microbes, reducing heat transfer across the surfaces or in other ways known in the art. The dispersant disclosed in the present embodiment removes or reduces the microbial slime without killing the microorganisms responsible for the adhesion. Therefore, the present methodology has beneficial environmental effects, as it presents minimal danger to non-target aquatic organisms present in waste treatment systems or to other recipients of the discharge due to its very low discharge concentrations. Additionally, the dispersant according to an embodiment of the present invention does not cause excess amounts of foam that would be unacceptable in many aquatic systems. Waters treated in the present manner are more acceptable for discharge to receiving streams having better aquatic toxicity profiles. Besides producing less foam, these Si-based polyalkyleneoxide polysiloxanes do not provide significant nutrient value to microbes as many currently used organic carbon based surfactants do.

An embodiment of the present invention provides a method for removing microbial biofilm on surfaces in contact with systems, including but not limited to aqueous systems, comprising adding to the system an effective amount of the Si-based dispersant comprised of polyalkyleneoxide polysiloxanes.

The polyalkyleneoxide polysiloxane employed in the present invention is more particularly defined by the general formula:

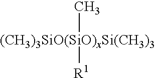

Such as the commercial Silwet™ surfactants (Momentive Performance Materials, Wilton, Conn.)
In the formula, x has a value of 1 to 2 and preferably x is 1. As set forth in the formula, R¹ has the formula:

CₙH₂ₙO(C₂H₄O)ₐ(C₃H₆O)_{b}R²

where
n has a value of 3 or 4, preferably n is 3;
a has a value of 1 to 15, preferably a is 6 to 9;
b has a value of 0 to 14, preferably b is 0 to 3; and most preferably b is 0;
a+b has a value of 5 to 15, preferably 6 to 9;
each R² is the same or different and is selected from the group consisting of hydrogen, and alkyl have 1 to 4 carbon atoms, and an acetyl group.

The dispersant comprises from about 20 to about 98 percent by weight of polyalkyleneoxide polysiloxane, with the remainder of the dispersant comprising water, which can be present in an amount of from about 2 to about 80% by weight. Additional components may included solvents, such as low molecular weight alcohols, for example, ethanol, methanol and butanol.

Polyalkyleneoxide polysiloxane surfactants maintain performance over a broad range of pH systems, and are therefore advantageous for use in various aqueous systems. The polyalkyleneoxide polysiloxane surfactants can be used in aqueous systems that have a pH of from about 6.0 to about 11.0.

The dispersant according to the present invention is preferably included in the aqueous system at a concentration of at least from about 2 parts per million (ppm) to about 400 ppm, with an alternative range of from about 20 to about 120 ppm, and a further embodiment of about 40 to about 60 ppm.

The systems that can be treated by the method and formulations disclosed herein are vast and varied, and may be any known systems involving chemical treatment for prevention and/or removal of microbial biofouling and macrofouling, particularly aqueous based systems. Macrofouling as used herein is understood as comprising larger organisms such as, but not limited to, shelled mollusks, hydrozoans, bryozoans, barnacles, sponges, and corals. As to industrial aqueous systems, the dispersant according to the present invention can be utilized in a variety of such systems, including but not limited to, commercial and industrial open recirculating cooling water towers, once-through and closed cooling water systems, cooling water conduits, heat exchangers, condensers, pasteurizers, air washers, heat exchange systems, air conditioning systems, humidifiers, dehumidifiers, hydrostatic cookers, safety and fire water protection storage systems, water scrubbers, disposal wells, influent water systems, including filtration and clarifiers.

In addition, the dispersants can be used in the treatment of wastewater, including, but not limited to wastewater treatment tanks, conduits, filtration beds, digesters, clarifiers, holding ponds, settling lagoons, canals, odor control systems, and ion exchange resin beds. With reference to membrane and filtration applications, the dispersants disclosed herein may be used in the treatment of membrane filtration, microfiltration, ultrafiltraton and nanofiltration membranes, reverses osmosis membranes and ultra pure water systems. In addition to the systems set forth above, other uses may include the use for example in food and beverage industries, for example in food and beverage disinfection systems.

The invention will now be described with respect to certain examples that are merely representative of the invention and should not be construed as limiting thereof.

### EXAMPLES

The invention is illustrated in the following non-limiting examples, which are provided for the purpose of representation, and are not to be construed as limiting the scope of the invention. All parts and percentages in the examples are by weight unless indicated otherwise.

In order to demonstrate efficacy of the present invention, a method was developed which allowed for the screening of dispersant ability to remove a bacterial biofilm. This method involved the colonization of commercially available 316 stainless steel coupons by bacteria, and their removal in the presence/absence of dispersants. The number of bacteria on a set of coupons was then determined by standard methods.

The bacterial species Pseudomonas fluorescens was chosen for these studies as this species is one that is common on freshwater, seawater, and brackish water submerged surfaces, and therefore would be one that could be expected to be found in process water streams.

The biofilm attached to the 316 stainless steel was formed by starting a 5 ml culture of Pseudomonas fluorescens in Nutrient Broth, it was incubated and shaken, overnight at 30° C. The next day, 1 ml of the culture was transferred into a 1.5 ml Eppendorf tube. The culture was then placed in a centrifuge for 10 minutes at 10,000 g at 4° C. The liquid was decanted and the cell pellet resuspended in 0.85% sterile saline.

The transfer and centrifuge of the culture was repeated. Thereafter, Pseudomonas fluorescens cell pellet was resuspended in 1 ml of 0.85% sterile saline buffer and diluted with sterile saline buffer to OD₆₀₀˜0.050±0.02. A #4 Whattman filter paper was placed on top of all the Nutrient Broth plates needed, and 2 ml of prepared cell suspension was placed on top of each filter. Three 316 stainless steel coupons were placed on the filter paper of each Petri dish, and they were incubated at 30° C. for 24 hours. Biofilm was allowed to form on one side of the two sided coupons.

In order to show biodispersant treatment for biofilm coated coupons, on the third day, simulation cooling tower water was prepared and filtered to sterilization. A biodispersant stock solution (10,000 ppm) was prepared. Each beaker was filled with 700 ml cooling water and then an amount of cooling water was removed from each beaker equal to the amount of biocide/or dispersant that will be added to each particular beaker.

Appropriate amounts of biodispersant were added to each beaker at the concentration levels to be tested. The solutions were thoroughly mixed using the multi-stirrer. One beaker was maintained as a control and contained only 700 ml of simulation cooling water. Thereafter, three coupons with biofilm were aseptically placed on coupon holders, and then each coupon holder was placed into a slot in the coupon holder lid. Beakers were placed on a multi-stirrer and the stirring action was adjusted to mix the solution in the beaker gently for 24 hours.

35 ml sterile saline buffer were placed into 50 ml centrifuge tubes and one biofilm coupon was aseptically transferred into each centrifuge tube. Sonication was properly conduct in each tube to remove any remaining Pseudomonas fluorescens biofilm bacteria from each coupon and dispersed in a saline buffer.

Serial dilutions were performed using sterile saline buffer. Biofilm cell dilutions were inoculated on Petrifilm (3M Company, St. Paul, Minn.). The Petrifilms are incubated at 30° C. for 48 hours, and the CFU (colony forming units) were read. Colony forming units (cfu)/cm² (Biofilm density) is determined by factoring the appropriate dilution and dividing the cell count obtained by 8.77 cm² (area of one side of a standard 316SS (stainless steel) corrosion coupon). The % of the biofilm removed was calculated by subtracting the above % calculation for each treatment from 100%. (biofilm controls minus treated).

(Optional calculation: % Reduction Achieved By Biodispersant=(Control Count-Treated Count)/Control Count)×100

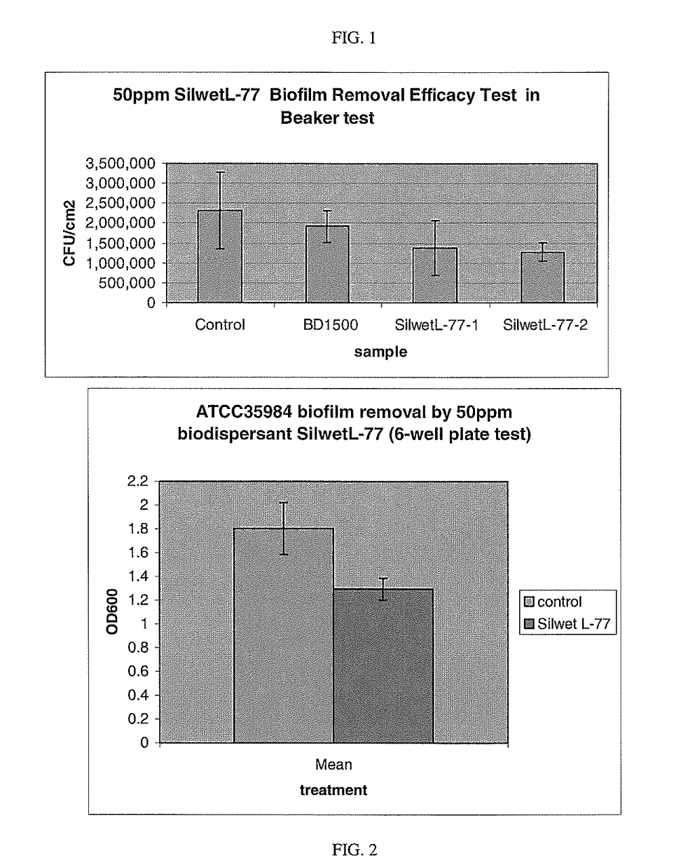

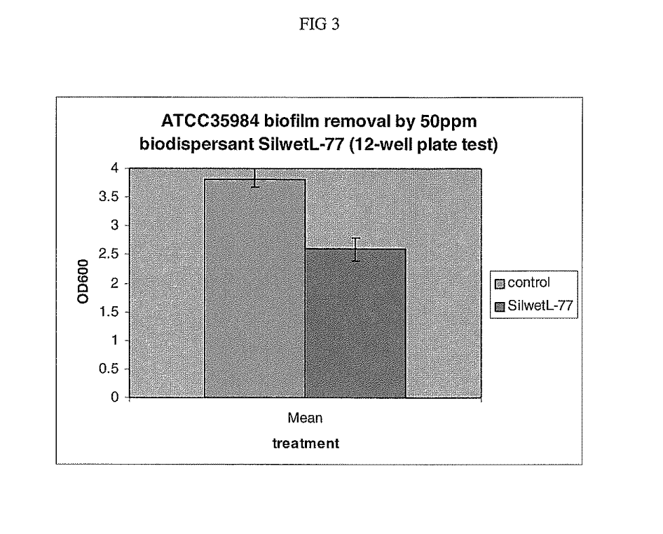

The results of the polyalkyleneoxide polysiloxanes on biofilm removal is shown in the charts below and the corresponding Figures. FIG. 1 relates to the results in Charts 1 and 2, FIG. 2 to Chart 3 and FIG. 3 to Chart 4. Results are shown for two different products, SilwetL-77-1, and SilwetL-77-2, both produced by Momentive Performance Materials of Wilton, Conn.

CHART I
Beaker-Test: 50 ppm BD1500 and SilwetL-77 Biofilm Removal Efficacy Test

| | | | cfu/cm2 | cfu/cm2 | | SD/cfu/cm2 |
|---|---|---|---|---|---|---|
| | | | (average) | (average) | SD | (average) |
| control | Coupon1 | 300,000 | 1,197,263 | | | |
| | Coupon2 | 700,000 | 2,793,615 | | | |
| | Coupon3 | 740,000 | 2,953,250 | 2,314,709 | 971,023 | 42.0% |
| 50 ppm BD1500 | Coupon1 | 380,000 | 1,516,534 | | | |
| | Coupon2 | 580,000 | 2,314,709 | | | |
| | Coupon3 | 480,000 | 1,915,621 | 1,915,621 | 399,088 | 20.8% |
| 50 ppm SilwetL-77-1 | Coupon1 | 460,000 | 1,835,804 | | | |
| | Coupon2 | 150,000 | 598,632 | | | |
| | Coupon3 | 430,000 | 1,716,078 | 1,383,504 | 682,351 | 49.3% |
| 50 ppm SilwetL-77-2 | Coupon1 | 260,000 | 1,037,628 | | | |
| | Coupon2 | 380,000 | 1,516,534 | | | |
| | Coupon3 | 320,000 | 1,277,081 | 1,277,081 | 239,453 | 18.8% |

CHART 2

| | cfu/cm2 | | |
|---|---|---|---|
| | (average) | SD | biofilm removal rate |
| Control | 2,310,000 | 970,000 | |
| BD1500 | 1,920,000 | 400,000 | 16.9% |
| SilwetL-77-1 | 1,380,000 | 680,000 | 40.3% |
| SilwetL-77-2 | 1,280,000 | 240,000 | 44.6% |

CHART 3
6-well plate biofilm removal test (ATCC35984 by
50 ppm biodispersant treatment)

| | OD600 | Mean | SD | SD/Mean |
|---|---|---|---|---|
| control | 2.177 | 1.803666667 | 0.395047255 | 21.9% |
| | 1.844 | | | |
| | 1.39 | | | |
| Silwet L-77 | 1.428 | 1.295333333 | 0.117172238 | 9.0% |
| | 1.206 | | | |
| | 1.252 | | | |
| | | | | biofilm |
| | Mean | SD | SD/Mean | removal rate |
| control | 1.803666667 | 0.395047255 | 0.219024536 | |
| Silwet L-77 | 1.295333333 | 0.117172238 | 0.090457209 | 27.80% |

CHART 4
12-well plate bioflim removal test (ATCC 35984 by 50 ppm
biodispersant treatment)

| | | | | Biofilm |
|---|---|---|---|---|
| | Mean | SD | SD/Mean | removal rate |
| Control | 3.802666667 | 0.129681662 | 0.034102821 | |
| SilwetL-77(1) | 2.594333333 | 0.193107051 | 0.07443417 | 31.80% |

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

What is claimed is:

1. A method for removing microbial biofilm on surfaces in contact with a system which comprises adding to the system an effective amount of a polyalkyleneoxide polysiloxane surfactant.

2. The method according to claim 1 wherein the system is an aqueous system.

3. The method according to claim 1 wherein the polyalkyleneoxide polysiloxane surfactant is present in the amount of from about 2 ppm to about 400 ppm.

4. The method according to claim 1 wherein the polyalkyleneoxide polysiloxane surfactant is present in the amount of from about 20 ppm to about 120 ppm.

5. The method according to claim 1 wherein the polyalkyleneoxide polysiloxane surfactant is present in the amount of from about 40 ppm to about 60 ppm.

6. The method according to claim 1 wherein the aqueous system has a pH of from about 3.5 to about 10.5.

7. The method according to claim 1 wherein the surfactant comprises from about 20 to about 98% by weight polyalkyleneoxide polysiloxane.

8. The method according to claim 1 wherein the surfactant comprises from about 40 to about 60% by weight polyalkyleneoxide polysiloxane.

9. The method according to claim 1 wherein the system is chosen from the group consisting of commercial and industrial water systems.

10. The method according to claim 1 wherein the water system is chosen from the group consisting of open recirculating cooling water towers, once-through and closed cooling water systems, cooling water conduits, heat exchangers, condensers, pasteurizers, air washers, heat exchange systems, air conditioning systems, humidifiers, dehumidifiers, hydrostatic cookers, safety and fire water protection storage systems, water scrubbers, disposal wells, influent water systems, including filtration and clarifiers.

11. The method of claim 1 wherein the system is a wastewater treatment system.

12. The method of claim 11 wherein the wastewater treatment system is chosen from the group consisting of wastewater treatment tanks, conduits, filtration beds, digesters, clarifiers, holding ponds, settling lagoons, canals, odor control systems, and ion exchange resin beds, microfiltration, ultrafiltraton and nanofiltration membranes, reverses osmosis membranes and ultra pure water systems, food and beverage disinfection systems.

13. A method for removing microbial biofilm on surfaces in contact with a system which comprises adding to the system an effective amount of a polyalkyleneoxide polysiloxane surfactant, wherein the polyalkyleneoxide polysiloxane is comprised of 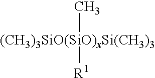
wherein, x has a value of 1 to 2; and
R¹ has the formula:
CₙH₂ₙO(C₂H₄O)ₐ(C₃H₆O)_{b}R²
where
n has a value of 3 or 4;
a has a value of from 1 to 15;
b has a value of from 0 to 14;
a+b has a value of from 5 to 15; and
each R² is the same or different and is selected from the group consisting of hydrogen, and alkyl have 1 to 4 carbon atoms, and an acetyl group.

14. The method of claim 13 wherein x has a value of 1, n has a value of 3, a has a value of from 6 to 9, b has a value of from 0 to 3 and a+b has a value of from 6 to 9.

15. The method of claim 13 wherein b has a value of 0.
